(19) United States
(12) Patent Application Publication
(10) Pub. No.: US 2009/0096187 A1
(43) Pub. Date: Apr. 16, 2009

(54) FOLDABLE JOINTED BICYCLE

(76) Inventors: Gilles Lapierre, Marsannay Ia Cote (FR); Emmanuel Antonot, Clenay (FR); Remy Gribaudo, Dijon (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/872,441

(22) Filed: Oct. 15, 2007

(51) Int. Cl. B62K 15/00

(52) U.S. Cl. 280/287

(57) ABSTRACT

The present invention relates to a foldable bicycle of the type including a chassis, a so-called frame (1), on the one hand, and a rear arm (15) firmly attached to the frame (1) and bearing the axis of the hub of a driving rear wheel (16) on the other hand, the driving torque being transmitted to the driving wheel (16) through a chain (17) extending between a driving pinion (13) firmly attached to the frame (1) and a driven pinion (18) firmly attached to the axis of the hub of the driving wheel (16); said bicycle is remarkable in that the rear arm (15) consists of at least two so-called horizontal arms (19a, 19b), one of the ends of which, a so-called proximal end, is jointed to the frame and the other end of which, a so-called distal end, bearing the axis of the hub driving rear wheel (16), is firmly attached to one of the ends of said rear oblique arms (20a, 20b), the other end, a so-called proximal end, of said rear oblique arms (20a, 20b) being provided with male or female firm attachment means capable of cooperating with female or respectively male firm attachment means of the seat tube (2) or of the horizontal tube (4) so that a user may firmly attach or detach the rear arm (15) from the frame (1) without using any free attachment part.

Another object of the invention relates to a bag intended to receive a foldable bicycle according to the invention.

The present invention relates to a foldable bicycle capable of being folded and stored, after removal of the wheels, in a substantially parallelepipedal bag.

In the field of cycles, bicycles which are foldable in order to limit their bulkiness when they are not used are well known.

Most of these collapsible bicycles consist of small wheels and of a frame including a vertical seat tube, and an oblique tube provided in its central portion with a joint so as to fold the frame along a vertical axis until the front wheel is at right angles of the rear wheel.

Such foldable bicycles are notably described in French patents FR 1 501 565, FR 1 443 948, FR 2 711 110 and in American patents US 2003/234509 and U.S. Pat. No. 5,836,602.

This type of foldable bicycle is intended for city use and is not adapted to sports practice of the standard road bicycle. A standard road bicycle consists of a triangular frame and of two wheels with a large diameter. By wheels of large diameter are meant wheels having a diameter larger than or equal 650 mm.

In order to allow road cyclists to transport their bicycle by plane, by train, etc., so as to practice their sport on their holiday location for example, foldable bicycles have already been devised which have road bicycle features in the unfolded configuration.

This is for example the case of European patent EP 1 298 046 which describes a bicycle frame consisting of two sections removably assembled by using a collar for assembling both portions of the oblique tube of the frame on the one hand, and a seat rod as a connecting member in order to form a junction of the seat tube and of the so-called horizontal tube.

This type of foldable bicycle has the drawback of requiring a long time for assembling and disassembling as well as certain accuracy during the placement of the collar for joining both junctions of the frame. Moreover, the junction of both sections of the frame by a collar forms a weak point of the frame which limits its rigidity and which is felt by the users. Further, with this type of junction for both sections of the frame, it is not possible to make the frame sections in lightweight tubes notably in aluminium or scandium, thereby forcing the sections to be made in heavy steel tubes.

Other types of foldable bicycles are known, in which the rear wheel is firmly attached to a so-called rear arm mounted so as to pivot about the crankset casing; for example this is the case for American patent U.S. Pat. No. 6,279,935, European patent EP 1 298 046 or British patent GB 2,296,224.

All these foldable bicycles have the drawback of having a significant bulkiness in the folded position, in addition to requiring removable attachment parts likely to be lost while storing and/or transporting the bicycle, subsequently making the bicycle unusable.

One of the objects of the invention is therefore to find remedy to all these drawbacks by providing a foldable bicycle of a simple and inexpensive design, having similar features in terms of rigidity, weight and feeling for the cyclist, with the features of a standard road or mountain bicycle, easy to fold and unfold, while being able to be stored after folding in a substantially parallelepipedal bag with small bulkiness.

For this purpose, and according to the invention, a foldable bicycle is proposed of the type including a chassis, a so-called frame, bearing a crankset casing and a fork tube bearing a fork, to the lower end of which is firmly attached the axis of the steering front wheel and to the upper end of which are attached steering means on the one hand, and a rear arm firmly attached to the frame and bearing the axis of the hub of a rear driving wheel on the other hand, the driving torque being transmitted to the driving wheel through a chain extending between a driving pinion firmly attached to the frame and a driven pinion firmly attached to the axis of the hub of the driving wheel; said bicycle is characterized in that the rear arm consists of two so-called horizontal arms, one of the ends of which, a so-called proximal end, is jointed to the frame and the other so-called distal end of which is respectively jointed to one of the ends of both so-called rear oblique arms, the other so-called proximal end of said rear oblique arms being provided with male or female firm attachment means capable of cooperating with female or respectively male firm attachment means of the frame.

It is well understood that unlike bicycles from the prior art, no free attachment part likely to be lost is required for its folding or unfolding. Moreover, the joint between the horizontal arms and the oblique arms of the rear arm allows the bicycle to be folded in a restricted space. Further, the bicycle according to the invention may be made with particularly lightweight aluminium or scandium tubes unlike the bicycles from the prior art.

Another object of the invention relates to a device for jointing a so-called rear arm bearing the hub of the rear wheel of a bicycle on a frame bearing a crankset casing, remarkable in that it consists of a semi-annular fixed jaw firmly attached to said rear arm and to the free end of which is jointed a semi-annular mobile jaw provided with means for attaching said mobile jaw to the fixed jaw, said fixed and mobile jaws being positioned on the crankset casing such that the rear arm is mounted so as to pivot about the axis of said crankset casing.

Each semi-annular fixed jaw advantageously includes a pin onto which the rear arm is able to fit.

Other advantages and features will become better apparent from the following description of several alternative embodiments, given as non-limiting examples, of the foldable bicycle according to the invention with reference to the appended drawings wherein:

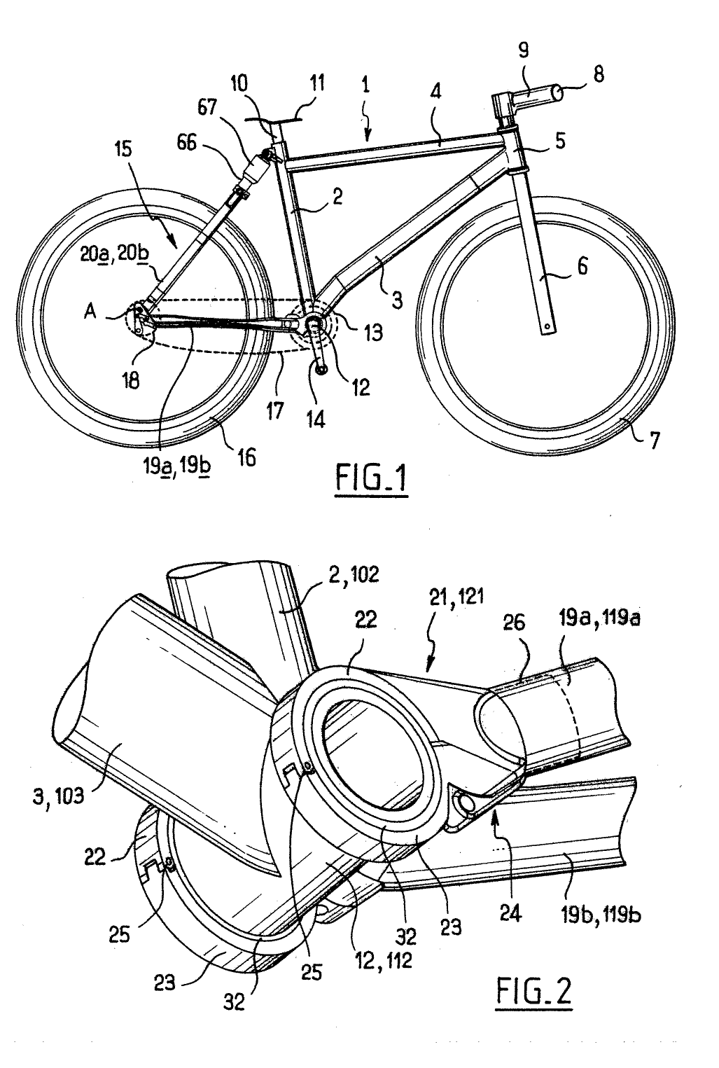

FIG. 1 is a side view of the foldable bicycle according to the invention in the unfolded position,

FIG. 2 is a perspective view of the jointing means of the rear arm on the crankset casing of the bicycle according to the invention,

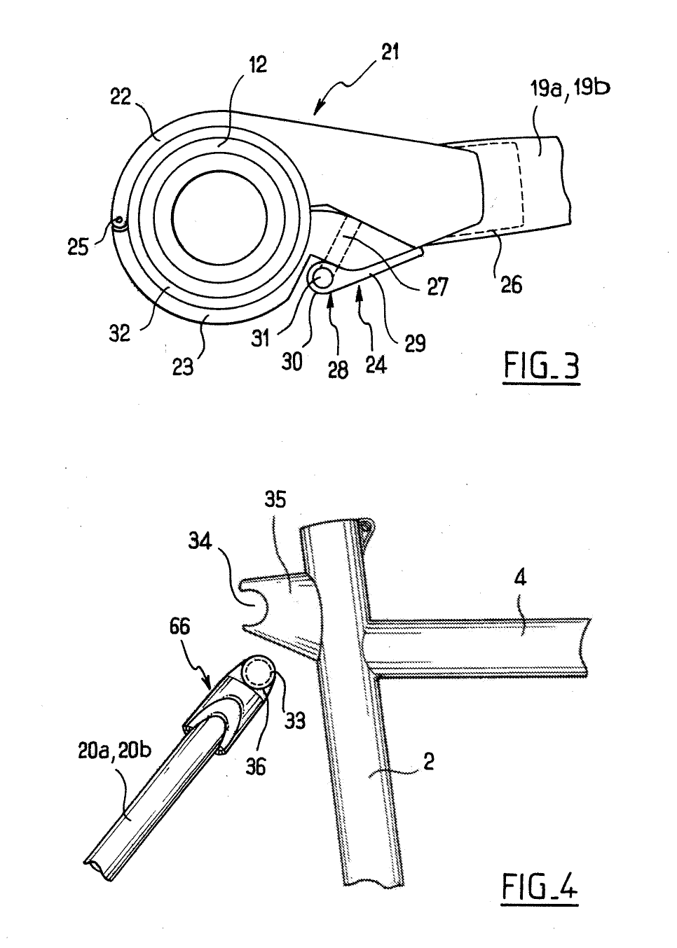

FIG. 3 is a longitudinal sectional view of the jointing means illustrated in FIG. 2,

FIG. 4 is a side view of the means for firmly attaching the rear arm to the seat tube of the bicycle according to the invention,

FIG. 5 is a top view of the means for firmly attaching the rear arm to the seat tube according to the invention illustrated in FIG. 4,

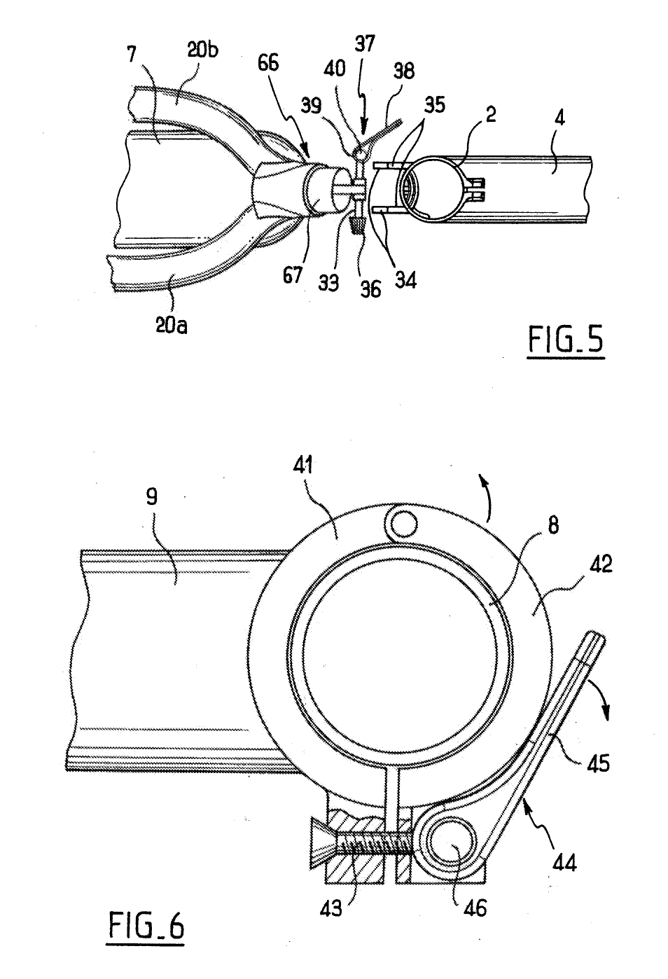

FIG. 6 is a side view of the means for firmly attaching the handlebar to the stem of the bicycle according to the invention,

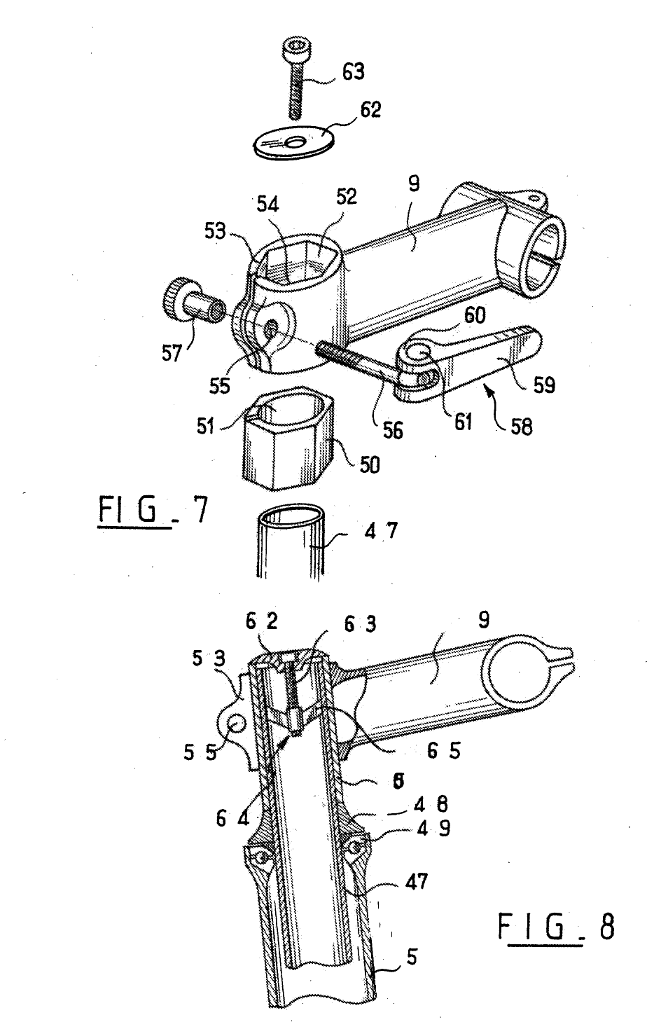

FIG. 7 is an exploded perspective view of the means for attaching the stem on the fork of the bicycle according to the invention,

FIG. 8 is a sagittal sectional view of the means for attaching the stem on the fork of the bicycle according to the invention, illustrated in FIG. 7,

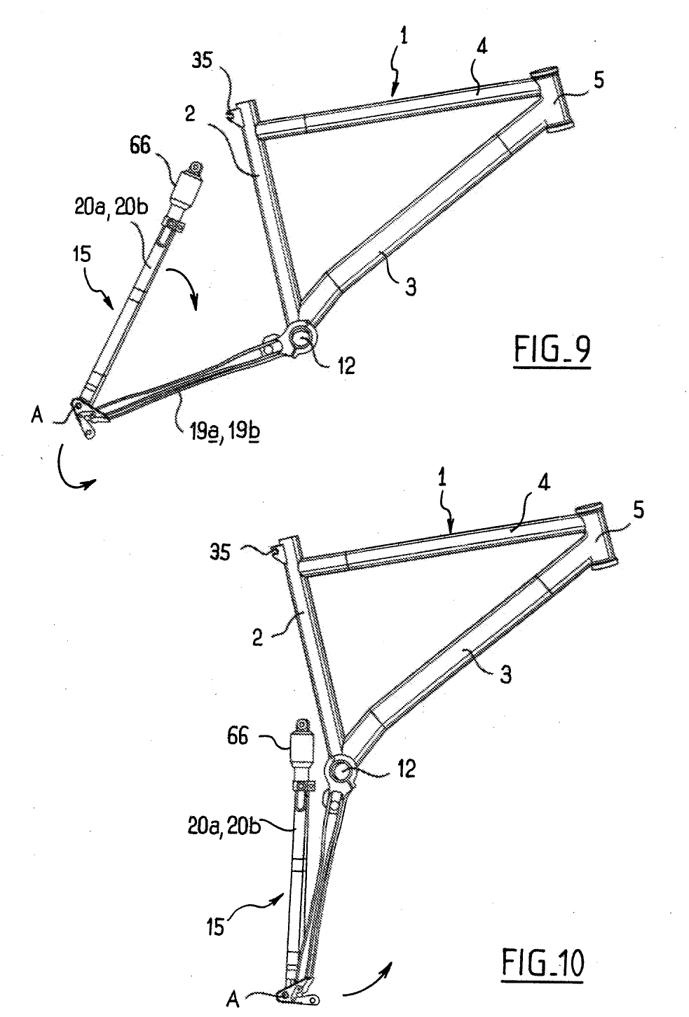

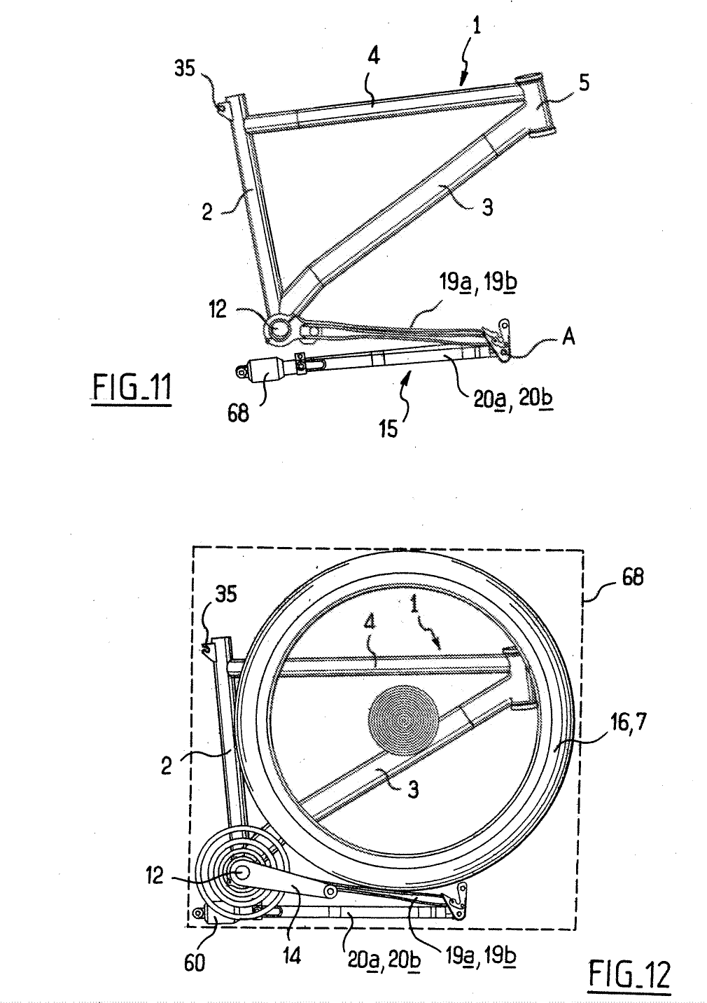

FIGS. 9 to 11 are side views of the different steps for folding the bicycle according to the invention,

FIG. 12 is a side view of the folded bicycle according to the invention,

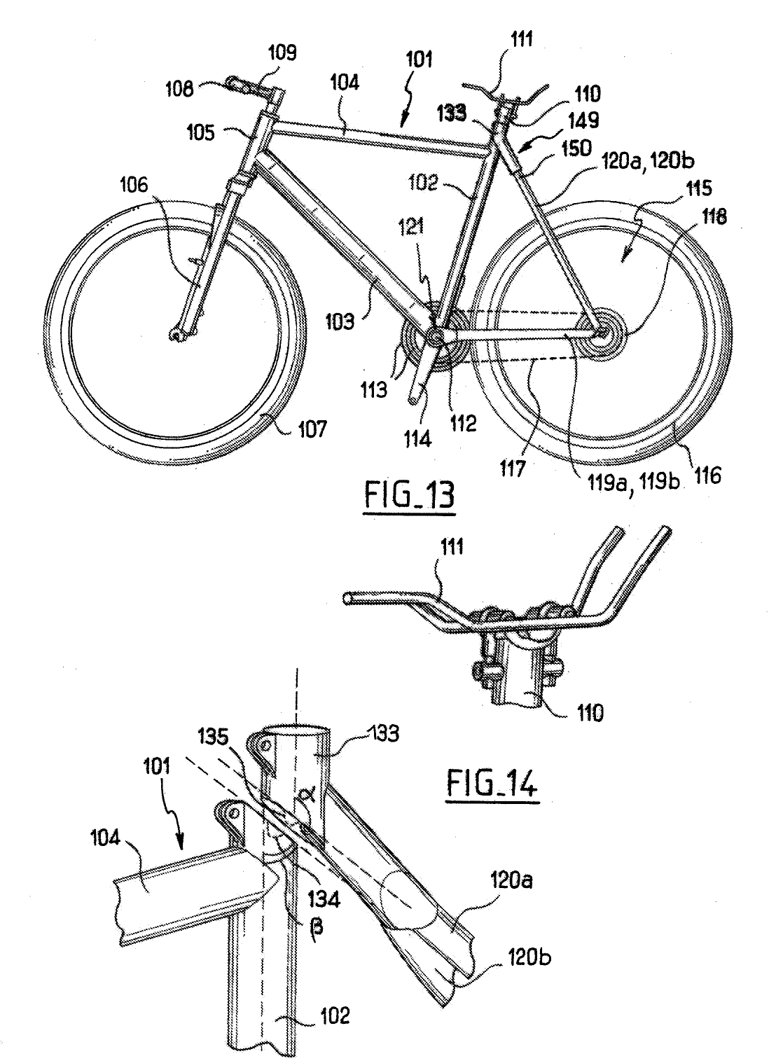

FIG. 13 is a side view of the foldable bicycle according to the invention in the unfolded position,

FIG. 14 is an exploded perspective view of the means for firmly attaching the rear arm to the seat tube of the bicycle according to the invention.

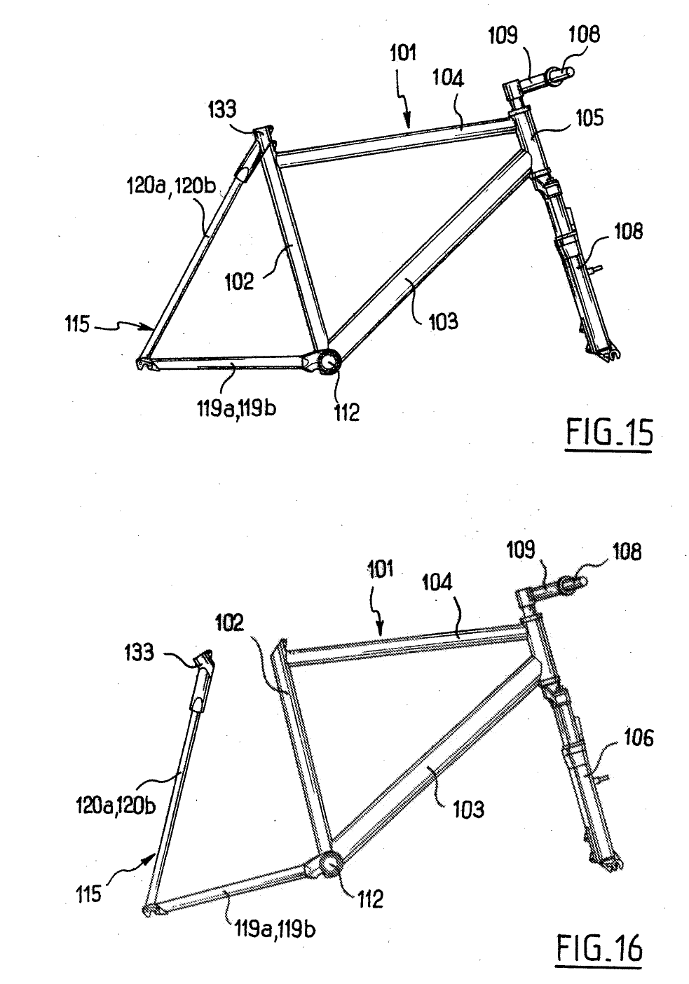

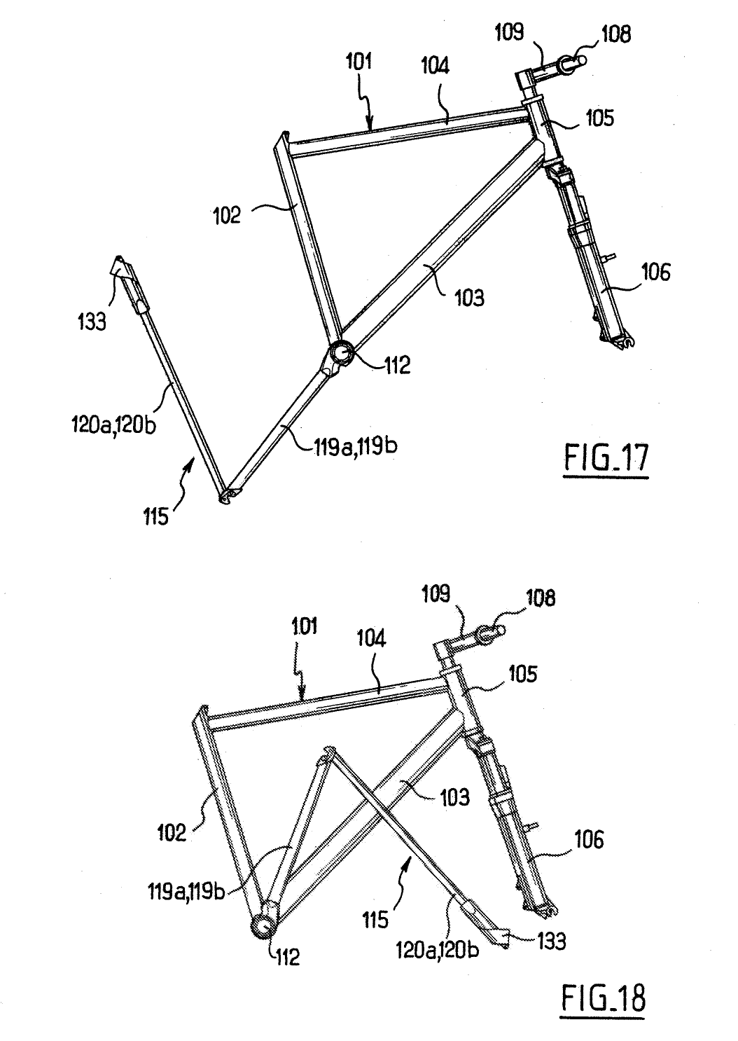

FIGS. 15 to 18 are side views of the different steps for folding the bicycle according to the invention,

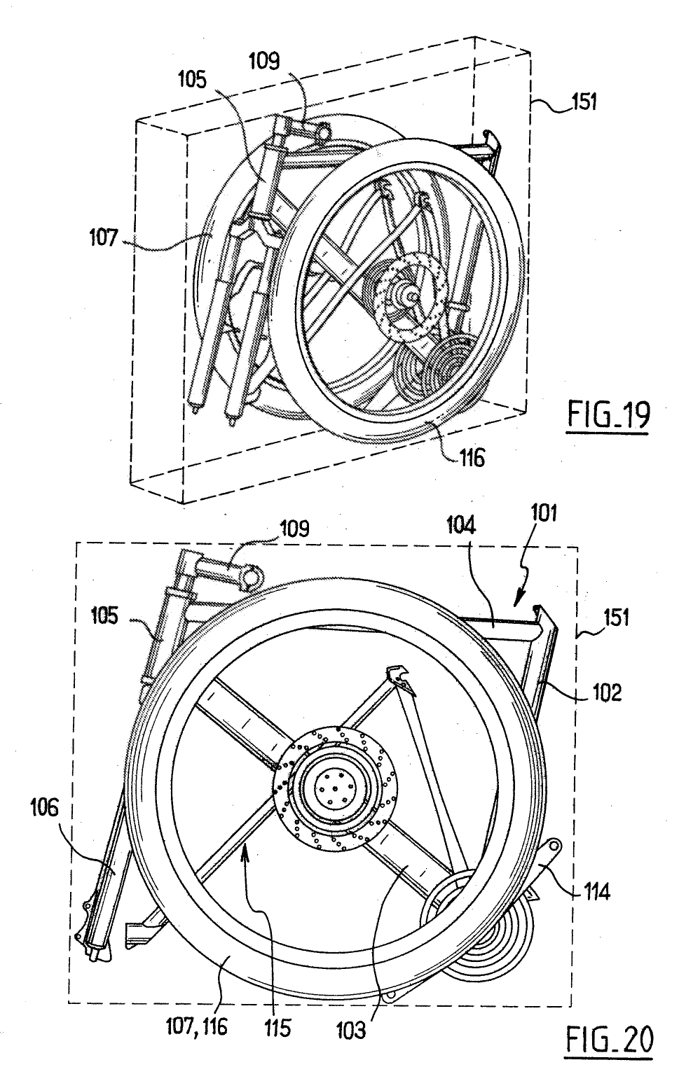

FIG. 19 is a perspective view of the folded bicycle according to the invention,

FIG. 20 is a side view of the folded bicycle illustrated in FIG. 19 according to the invention,

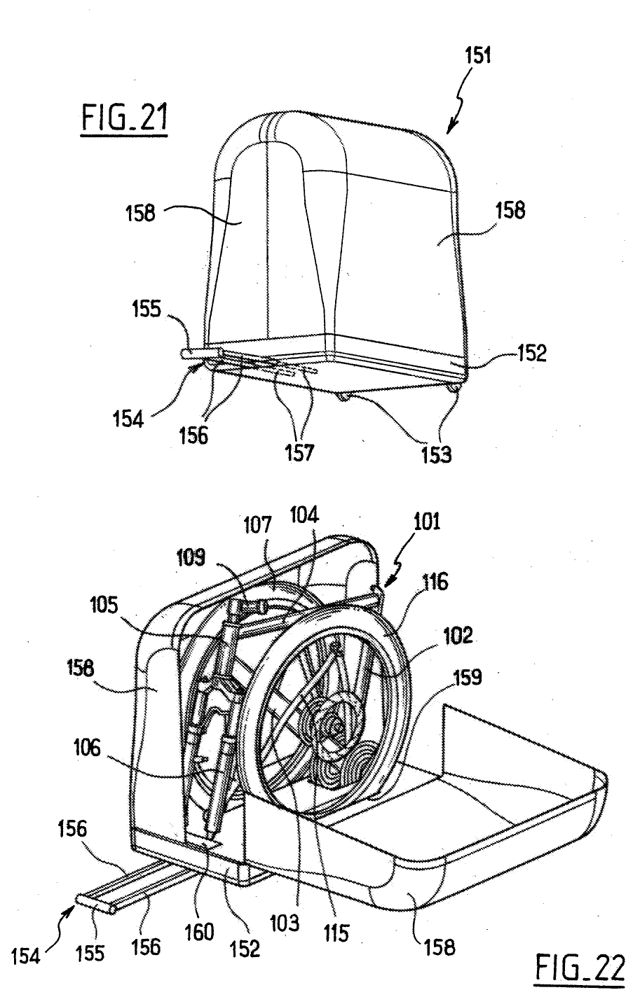

FIG. 21 is a perspective view of the bag, in the closed position, capable of receiving the foldable bicycle according to the invention,

FIG. 22 is a perspective view of the bag, in the half open position, capable of receiving the foldable bicycle according to the invention,

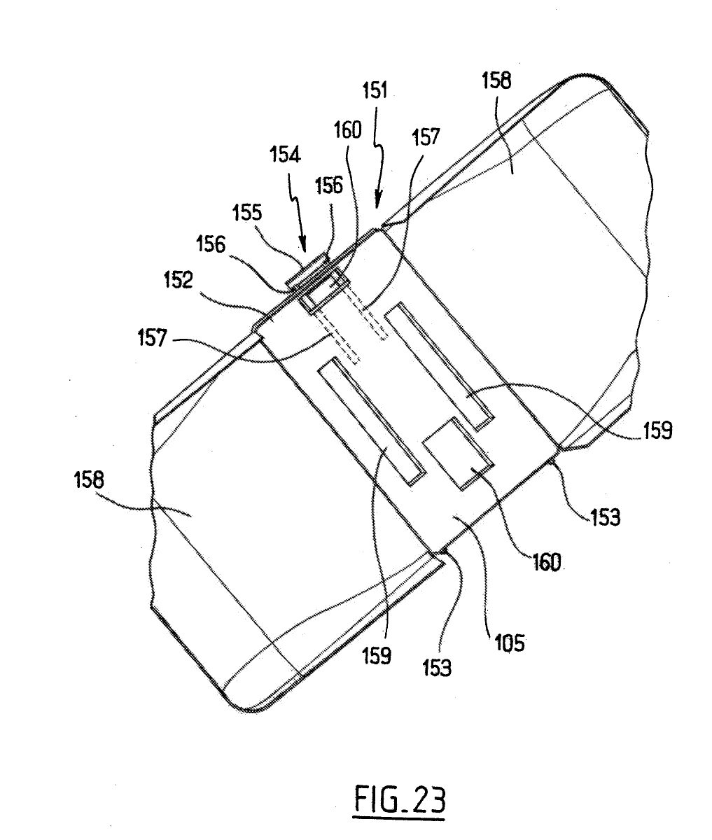

FIG. 23 is a top view of the bag, illustrated in FIGS. 21 and 22, in the open position.

As a non-limiting example, a foldable bicycle of the mountain bike type (MB) will be described hereafter; 5 nevertheless the folded bicycle according to the invention may be adapted to a so-called road bicycle or the like.

With reference to FIG. 1, the bicycle comprises a chassis 1, a so-called triangled frame consisting of a globally vertical seat tube 2, of an oblique tube 3 assembled by welding to the lower end of the seat tube 2, a horizontal tube 4, the ends of which are respectively assembled by welding to the upper end of the seat tube 2 and to a globally vertical fork tube 5, the oblique tube 3 being moreover firmly attached to said fork tube 5 also by welding. This fork tube 5 receives a fork 6 of the telescopic type bearing at its lower end the axis of the hub of the front wheel 7 of the bicycle. A handlebar 8 is removably attached as this will be detailed later on, to the free end of a stem 9 firmly attached to the fork 5.

The seat tube 2 is capable of receiving a seat rod 10 comprising at its upper end a seat 11 on which the cyclist assumes a position.

Said seat tube 2 comprises at its lower end, i.e., at the intersection of the oblique tube 3 and of the seat tube 2, a crankset casing 12 bearing in a standard way the axis of the driving pinions 13 commonly called chain wheels, the axes of rotation of which are coaxial. Pedals 14 are firmly attached to the axis of the driving pinions 13 on either side of the frame 1 of the bicycle.

It is obvious that the frame 1 of the bicycle may consist in a frame, a so-called <<beam >> frame, only including a so-called oblique tube 3 and a so-called horizontal tube 4, the lower and upper ends of the oblique tube 3 being firmly attached to the crankset casing 12 and to the fork tube 5, respectively. A first end of the horizontal tube 3 bears the seat 11 and the opposite end is either firmly attached to the fork tube 5 or to the horizontal tube 3.

Further, the bicycle may consist in a so-called <<beam >> frame only including a so-called tube 3 and a so-called seat tube 2, or only including a so-called seat tube 2 and a horizontal tube 3 without however departing from the scope of the invention.

Said bicycle moreover comprises a rear arm 15 firmly attached to the frame 1 and bearing the axis of the hub of a driving rear wheel 16, the driving torque being transmitted to the driving wheel 16 through a chain 17, illustrated in dotted lines in FIG. 1, extending between a driving pinion 13 10 and a driven pinion 18 firmly attached to the axis of the hub of the driving wheel 16. The rear arm 15 consists of at least two so-called horizontal arms 19a, 19b, said arms 19a and 19b globally extending parallel on either side of the sagittal plane of the frame 1, one of the ends of which, a so-called proximal end, is jointed to the frame 1 around a joint A. The other so-called distal end of said horizontal arms 19a, 19b bears the axis of the hub of the driving rear wheel 16 and is jointed to a so-called distal one of the ends of two so-called rear oblique arms 20a, 20b. The other so-called proximal end of said rear oblique arms 20a, 20b is provided with male or female firm attachment means capable of cooperating with female or respectively male firm attachment means of the seat tube 2 or of the horizontal tube 3 of the frame 1 so that a user may firmly attach or detach the rear arm 15 from the frame 1 without using any free attachment part as this will be detailed later on.

The different tubes forming the frame 1 and the rear arm 15 are advantageously made in aluminium or scandium so that the bicycle is lightweight while being rigid.

In a particularly advantageous way, with reference to FIGS. 1 to 3, each horizontal arm 19a, 19b of the rear arm 15 is mounted so as to pivot about the axis of the crankset casing 12 positioned at the lower end of the seat tube 2 and of the oblique tube 3. For this purpose, each horizontal arm 19a, 19b of the rear arm 15 includes jointing means 21 consisting of a semi-annular fixed jaw 22, to the free end of which is jointed a semi-annular mobile jaw 23 provided with means 24 for attaching said mobile jaw 22 to the fixed jaw 23. The mobile jaw 23 is jointed to the fixed jaw around an axis 25 extending parallel to the axis of the crankset casing 12 when the jointing means 21 are firmly attached to said crankset casing 12. Each fixed jaw 22 includes a pin 26 illustrated in dotted lines in FIGS. 2 and 3, onto which the horizontal arm 19a or 19b of the rear arm 15 is able to fit, each horizontal 19a, 19b having a hollow proximal end with a section corresponding to the section of the pin 26. It will be noted that such a structure allows the rear arm 15 to be easily mounted on the frame 1 without requiring deformation of the horizontal arms 19a, 19b of the rear arm 15. Thus, during the assembling of the rear arm 15, the jointing means 21 consisting of a fixed jaw 22 and a mobile jaw 23 respectively are opened beforehand and then positioned on either side of the sagittal plane of the frame 1 on the crankset casing 12. Next, the mobile jaw 23 is closed on the fixed jaw 22 and held in position by means 24 for attaching the fixed jaw 22 relatively to the mobile jaw 23.

These attachment means 24, with reference to FIG. 3, advantageously consist of a tie rod 27 extending at the free end of the mobile jaw 23, capable of engaging with the fixed jaw 22 and cooperating with means 28 for clamping and pulling under tension said tie rod 27 in order to exert a pressure of the mobile jaw 23 on the crankset casing 12 placed between the fixed 22 and mobile 23 jaws. Said clamping and pulling means 28 consist of a handle 29 including a cylindrical head 30 rotatably mounted around an eccentric axis 31 parallel to the axis of rotation 25 of the jaws 22, 23, said tie rod 27 being firmly attached to the handle 29.

It is obvious that the attachment means 24 may consist in any equivalent blocking means well-known to one skilled in the art, such as for example a screw cooperating with a tapped hole made in the fixed jaw 22 and the mobile jaw 23 without departing from the scope of the invention.

Moreover, in order to facilitate the rotation of the rear arm 15 around the crankset casing 12, an annular rolling bearing 32 extending on either side of the frame 1 is positioned on said cylindrical crankset casing 12 which protrudes on either side of the frame 1, the fixed 22 and mobile 23 jaws of the jointing means 21 being firmly attached by clamping on said annular rolling bearings 32.

With reference to FIGS. 4 and 5, the proximal end of the rear oblique arms 20a, 20b is provided with an axis 33 extending perpendicularly to said rear oblique arms 20a, 20b, i.e., perpendicularly to the sagittal plane of the frame 1, forming a tie rod capable of cooperating with two U-shaped notches 34 provided at the free end of at least two parallel tabs 35 extending from the seat tube 2 towards the rear of the bicycle and comprising at its free ends a nut 36 and means 37 for clamping and pulling under tension said tie rod 33 in order to block said tie rod 33 in the notches 34.

It is of course obvious that the notches 34 may be substituted by a groove with a U-shaped section formed at the free end of a tab extending from the seat tube 2 towards the rear of the bicycle.

Said clamping and pulling means 37 consist of a handle 38, the cylindrical head 39 of which is rotatably mounted around an eccentric axis 40 perpendicular to the longitudinal axis of the tie rod 33 and cooperating with flanks of the tabs 35.

According to an alternative embodiment of the bicycle according to the invention, not shown in the figures, the proximal end of the rear oblique arms 20a, 20b is provided with a groove with a U-shaped section, the longitudinal axis of which extends perpendicularly to the rear oblique arms 20a, 20b, i.e., perpendicularly to the sagittal plane of the frame 1, and capable of receiving an axis firmly attached to the frame 1 and extending perpendicularly to the sagittal plane of the latter, said axis forming a tie rod which comprises at its free ends a nut and means for clamping and pulling under tension said tie rod, respectively, in order to block the tie rod in the groove. Said clamping and pulling means then consist of a handle, the cylindrical head of which is rotatably mounted around an eccentric axis perpendicular to the longitudinal axis of the tie rod and cooperating with the flanks of the rear oblique arms 20a, 20b.

With reference to FIGS. 1 and 6, the handle bar 8 is removably attached to the free distal end of the stem 9 firmly attached to the fork 5 by attachment means. Said attachment means consist of a semi-cylindrical fixed jaw 41 firmly attached to the free end of the stem 9 and of a semi-cylindrical mobile jaw 41 jointed to the fixed jaw 41, said attachment means including means for blocking the fixed jaw 41 relatively to the mobile jaw 42 for providing clamping of the handle bar 8 between the fixed 41 and mobile 42 jaws. These blocking means consist of a tie rod 43 capable of engaging with the free end of the mobile jaw 42 and cooperating with means 44 for clamping and pulling under tension said tie rod 43 so as to exert a pressure of the mobile jaw 42 on the handle bar 8 placed between the fixed 41 and mobile 42 jaws. These clamping and pulling means 44 consist of a handle 45 rotatably mounted around an axis 46 parallel to the axis of the jaws 41 and 42, said tie rod 43 being firmly attached to the handle 45.

It will be noted that such means for attaching the handle bar 8, or any other steering means, allow said handle bar 8 to be attached or removed without using any free attachment part which the cyclist may lose when folding or unfolding the bicycle.

It is of course obvious that the mobile jaw 42 may be jointed to the free end of the stem 9 without however departing from the scope of the invention.

With reference to FIGS. 7 and 8, the means for firmly attaching the stem 9 to the fork tube consist of a cylindrical connecting part 47, the lower end of which is firmly attached to a crown 48 engaged with an annular rolling bearing 49 firmly attached to the upper end of the fork tube 5. The upper end of this connecting part 47 is capable of receiving a deformable member 50 with a hexagonal shape, or the like, including a cylindrical central recess 51 with an inner diameter only just equal to the outer diameter of the connecting part 47 so that the deformable member is able to slide along the connecting part 47. Said deformable member 50 is capable of being introduced into a recess 52 with a hexagon-shaped section, or the like, formed between two deformable fixed jaws 53 and 54 of the proximal end of the stem 9. Said fixed jaws 53 and 54 respectively include a hole 55 letting through a tie rod 56, the free ends of which respectively comprise a nut 57 and means 58 for clamping and pulling under tension said tie rod 56 in order to clamp the jaws 53 and 54 on the deformable member 50. Said clamping and pulling means 58 consist of a handle 59, the cylindrical head of which 60 is rotatably mounted around an eccentric axis 61 perpendicular to the longitudinal axis of the tie rod 56 and cooperating with the flanks of the jaws 53 and 54.

Said firm attachment means moreover include a cap 62 supported on the upper end of the jaws 53 and 54 and letting through a screw 63 cooperating with a star-shaped part 64, the branches of which 65 are supported on the inner wall of the cylindrical connecting part 47.

Thus, the cyclist may adjust the direction of the stem 9 relatively to the fork tube 5 on the one hand, and adjust the height of said stem 9 by opening and then closing the handle 59 on the other hand, after having adjusted said direction and/or said height of the stem.

Moreover, with reference to FIG. 1, the rear oblique arms 20a, 20b of the rear arm 15 converge into a single tube segment 66 in proximity to their distal ends, said single tube segment 66 being provided with means for firmly attaching the rear oblique arms 20a, 20b to the seat tube 2.

In a particular advantageous way, the rear arm 15 includes a damper 67 or any other equivalent damping means well-known to one skilled in the art, positioned between the axis of the hub of the rear wheel 16 and the means for firmly attaching the rear oblique arms 20a, 20b to the seat tube 2, and more specifically positioned at the single tube segment 66.

The different steps for folding the bicycle according to the invention will now be described, with reference to FIGS. 1 and 9-11.

With reference to FIGS. 1 and 9, the front 7 and rear 16 wheels are removed beforehand, and then the handle 38 of the clamping and pulling means 37 is opened in order to release the tie rod 33 from the notches 34. Thus, as the rear oblique arms 20a and 20b are released, the rear arm 15 is free to rotate from now on around the crankset casing 12. The rear oblique arms 20a and 20b of the rear arm 15 are then driven into rotation, with reference to FIGS. 9-11, towards the horizontal arms 19a and 19b around their joint A until the rear oblique tubes 20a, 20b globally extend parallel to the horizontal arms 19a, 19b. Successively or simultaneously, the horizontal arms 19a, 19b of the rear arm 15 are driven into rotation around the crankset casing 12 until the oblique 20a, 20b and horizontal 19a, 19b arms extend parallel to the horizontal tube 4 of the frame 1.

After having removed the handlebar 8 and stem 9 assembly by opening the handle 59, with reference to FIG. 7, the front 7 and rear 16 wheels are respectively placed on either side of the frame 1, with reference to FIG. 12, so that they extend parallel to the frame 1 above the oblique 20a, 20b and horizontal 19a, 19b arms of the rear arm 15. The thereby folded bicycle is capable of being contained in a bag 68 defining a volume inscribed in a parallelepiped. This bag 68 is obtained in a semi-rigid material and has a length and an internal height on the one hand, only just larger than the diameter of the front 7 and rear 16 wheels and an internal depth on the other hand only just larger than the sum of the thicknesses of the frame 1 and of the front 7 and rear 16 wheels. As a non-limiting example, for a bicycle, the wheels of which have a diameter of 675 mm, the bag has a length of about 800 mm, a height of about 800 mm and a thickness of about 450 mm. Preferably, the bag 68 has a length and a height between 1.2 and 1.4 times the diameter of the wheels (7, 16) of said bicycle and a depth between 420 and 440 mm. It is obvious that the rear arm 15 may be jointed to the frame 1 by any suitable means, the so-called rear oblique arms 20a, 20b of the rear arm 15 may for example be firmly and removably attached to the so-called horizontal tube 4 of the frame 1.

According to an alternative embodiment of the device according to the invention, with reference to FIG. 13, the latter comprises a chassis 101, a so-called triangled frame, consisting of a globally vertical seat tube 102, of an oblique tube 103 assembled by welding to the lower end of the seat tube 102, a horizontal tube 104, the ends of which are respectively assembled by welding to the upper end of the seat tube 102 and to a globally vertical fork tube 105, the oblique tube 103 being moreover firmly attached to said fork tube 105 also by welding. This fork tube 105 receives a fork 106 of the telescopic type bearing at its lower end the axis of the hub of the front wheel 107 of the bicycle. A handle bar 108 is attached removably, as this will be detailed later on, to the free end of a stem 109 firmly attached to the fork 105.

The seat tube 102 is capable of receiving a seat rod 110 comprising at its upper end a seat 111 on which the cyclist assumes a position.

Said seat tube 102 comprises at its lower end, i.e., at the intersection of the oblique tube 103 and of the seat tube 102, a crankset casing 112 bearing in a standard way the axis of the driving pinions 113 commonly called chain wheels, the axis of rotation of which are coaxial. Pedals 114 are firmly attached to the axis of the driving pinions 113 on either side of the frame 101 of the bicycle.

It is obvious that the frame 101 of the bicycle may include a so-called <<beam >> frame only including a so-called oblique tube 103 and a so-called horizontal tube 104, the lower and upper of the oblique tube 103 being firmly attached to the crankset casing 112 and to the fork tube 105, respectively. A first end of the horizontal tube 103 bears the seat 111 and the opposite end is either firmly attached to the fork tube 105 or the horizontal tube 103.

Further, the bicycle may include a so-called <<beam >> frame only including a so-called oblique tube 103 and a so-called seat tube 102 or only including a so-called seat tube 102 and a horizontal tube 103 without however departing from the scope of the invention.

Said bicycle moreover comprises a rear arm 115 firmly attached to the frame 101 and bearing the axis of the hub of a driving rear wheel 116, the driving torque being transmitted to the driving wheel 116 through a chain 117, illustrated in dotted lines in FIG. 13, extending between a driving pinion 113 and a driven pinion 118 firmly attached to the axis of the hub of the driving wheel 116. The rear arm 115 consists of at least two so-called horizontal arms 119a, 119b, said arms 119a and 119b globally extending parallel on either side of the sagittal plane of the frame 101, one of the ends of which, a so-called proximal end, is jointed to the frame 101. The other so-called distal end of said horizontal arms bears the axis of the hub of the driving rear wheel 116 and is firmly attached to one of the ends, a so-called distal end, of two so-called rear oblique arms 120a, 120b. The other so-called proximal end of said rear oblique arms 120a, 120b is provided with male or female firm attachment means capable of cooperating with female or respectively male firm attachment means of the seat tube 102 or of the horizontal tube 103 so that a user may firmly attach or detach the rear arm 115 of the frame 101 without using any free attachment part as this will be detailed later on.

The different tubes forming the frame 101 and the rear arm 115 are advantageously made in aluminum or in scandium so that the bicycle is lightweight while being rigid; however it is quite obvious that said tubes may be made in a heavier material such as steel without however departing from the scope of the invention.

In a particularly advantageous way, with reference to FIGS. 13, 2 and 3, each horizontal arm 119a, 119b of the rear arm 115 is mounted so as to pivot about the axis of the crankset casing 112 positioned at the lower end of the seat tube 102 and of the oblique tube 103. For this purpose, each horizontal arm 119a, 119b of the rear arm 115 includes jointing means 121 fully compliant with the jointing means 21 described earlier with reference to FIGS. 2 and 3.

With reference to FIGS. 13 and 14, the proximal end of the rear oblique arms 120a, 120b is provided with a tube segment 133 of the same section as the section of the seat tube 102 and the lower edge of which, facing the horizontal arm 119a, 119b, is capable of being supported on the upper edge of the seat tube 102 protruding above the horizontal tube 104 in order to removably connect the rear arm 115 to the frame 101 by insertion of the seat rod 110 into the tube segment 133 of the rear oblique arms 120a, 120b and the seat tube 103. The lower and the upper edges of the tube segment 133 of the rear oblique arms 120a, 120b extend in a plane globally parallel to the longitudinal axis of said rear oblique arms 120a, 120b and respectively in a plane forming an angle α with the axis of said tube segment 133 of the rear oblique arms 120a, 120b. Moreover, the upper edge of the seat tube 102 extends in a plane tilted from top to bottom and from front to rear by forming an angle β with the longitudinal axis of said seat tube 102.

In order to avoid any shearing of the seat rod 111, when using the bicycle, and notably upon passing over obstacles, the upper edge of the seat tube 102 includes a recess 134, illustrated in dotted lines in FIG. 14, which fits into a protrusion 135, also illustrated in dotted lines in FIG. 14, with a shape corresponding to the lower edge of the tube segment 133 of the rear oblique arms 120a, 120b.

It is obvious that the upper edge of the seat tube 102 may include one or more protrusions which will fit into one or more recesses of corresponding shape of the lower edge of the tube segment 133 of the rear oblique arms 120a, 120b without however departing from the scope of the invention.

Moreover, with reference to FIG. 13, the rear oblique arms 120a, 120b of the rear arm 115 converge into a single tube segment 149 in proximity to their distal ends, said single tube segment 149 being provided with means for firmly attaching the rear oblique arms 120a, 120b to the seat tube 2.

The different steps for folding the bicycle according to the invention will now be described, with reference to FIGS. 13 and 15-20.

With reference to FIGS. 13 and 15, the front 107 and rear 116 wheels are removed beforehand, and then the seat rod 111 is removed from the seat tube 102 and from the tube section 133 firmly attached to the rear oblique arms 120a, 120b in order to release the rear arm 115 which is free to rotate from now on around the crankset casing 112. The rear arm 115 is then driven into rotation, with reference to FIGS. 16-18, around said crankset casing 112 until the distal end of the horizontal arms 119a,119b of the rear arm 115 extends between the oblique 103 and horizontal 104 tubes of the frame 101 and the means for firmly attaching the rear oblique arms 120a ,120b, i.e. the tube section 133, extending between the oblique tube 103 of the frame 101 and a line passing through the crankset casing 112 and the lower end of the fork 105. After rotation of the rear arm 115, the seat rod 111 may possibly be reintroduced into the seat tube 102.

After having removed the handlebar 108 and having placed the front 107 and rear 116 wheels respectively on either side of the frame 101, with reference to FIGS. 19 and 20, the folded bicycle is capable of being contained in a bag 151 defining a volume inscribed in a parallelepiped. This bag 151 is obtained in a semi-rigid material and has a length and an internal height on the one hand only just larger than the diameter of the front 107 and rear 116 wheels and an internal depth on the other hand only just larger than the sum of the thicknesses of the frame 101 and of the front 107 and rear 116 wheels. As a non-limiting example, for a bicycle, the wheels of which have a diameter of 675 mm, the bag has a length of about 800 mm, a height of about 800 mm and a thickness of about 450 mm. The bag 151 has a length and a height between 1.1 and 1.3 times the diameter of the wheels 7,16, and preferably 1.18 and 1.2 times the diameter of the wheels 7,16 of said bicycle, and a depth between 440 and 460 mm. With reference to FIGS. 20-22, the bag 151 consists of a rectangular base 152 including along one of its side edges, castors 153 protruding under the lower face of the base 152, and telescopic gripping means 154 along its opposite side edge. These telescopic gripping means 154 consist in a handle 155 extending to the free ends of two parallel tubular arms 156 capable of sliding in sheaths 157 made in the base 152. Said arms 156 are capable of being displaced from a retracted position where the arms 156 entirely extend into the sheaths 157 and the handle 155 extends along the side edge of said base 152 up to an active position where said arms 156 protrude from the sheaths 157 and vice versa.

Moreover, the bag 151 consists of two shells 158 respectively jointed around a hinge along the longitudinal edges of the base 152, to the upper face of said base 512, each shell 158 including closing means and complementary closing means so that said shells 158 form a globally parallelepipedal volume in the closed position.

It is obvious that said shells 158 may be jointed along the side edges of the base 152 without however departing from the scope of the invention.

Moreover, it is of course obvious that the bag 151 may consist of a base 152 and of one or more shells 158 capable of cooperating with said base 152 so that the shell(s) and the base 152 form a globally parallelepipedal volume in the closed position.

These semi-rigid shells 158 for example are heat-moulded shells or shells obtained in a semi-rigid tissue.

With reference to FIGS. 21 and 22, the upper face of the base 152 includes two parallelepipedal recesses 159 extending parallel along the longitudinal edges of the base 152, on either side of the sagittal plane of symmetry of the base 152. These recesses 159 are capable of receiving the front 107 and rear 116 wheels when they are stored in the bag 151. The upper face of the base 152 moreover includes two other so-called side parallelepipedal recesses 160 globally extending in the sagittal plane of the base 152, extending in proximity to the side edges of said base 152 respectively, and capable of receiving the pinions of the crankset casing of the bicycle and the lower end of the fork of said bicycle, respectively.

These recesses 159 and 160 allow the different components of the bicycle to be held in position, i.e. the frame and the wheels, during its transport.

It is obvious that the bag 151 may receive the foldable bicycle described in FIGS. 1-12 without departing from the scope of the invention.

Further, it is obvious that the rear arm 15 or 115 may be jointed to the frame 1 or 101 by any suitable means, the so-called rear oblique arms 20a, 20b or 120a,120b of the rear arm 15 or 115 may for example be firmly and removably attached to the so-called horizontal tube 4, 104 of the frame 1, 101.

Finally, it is of course obvious that the foldable bicycle according to the invention may be adapted for a road bicycle, the telescopic fork then being substituted by a rigid fork and the damper 50 being removed, and that the examples which have just been given are only particular, by no means limiting, illustrations, as for the fields of application of the invention.

1. A foldable bicycle including:
a chassis, a so-called frame (1), bearing a crankset casing (12) and a fork tube (5) bearing a fork (6) at the lower end of which is firmly attached the axis of the front steering wheel (7) and at the upper end of which are firmly attached steering means (8, 9),
a rear arm (15) firmly attached to the frame (1) and bearing the axis of the hub of a driving rear wheel (16) on the other hand, the driving torque being transmitted to the driving wheel (16) through a chain (17) extending between a driving pinion (13) firmly attached to the frame (1) and a driven pinion (18) firmly attached to the axis of the hub of the driving wheel (16);
said rear arm (15) consists of two so-called horizontal arms (19a,19b), one of the ends, a so-called proximal end, is jointed to the frame and the other so-called distal end is respectively jointed to one of the ends of two arms, so-called rear oblique arms (20a,20b), the other so-called proximal end of said rear oblique arms (20a, 20b) being provided with male or female firm attachment means capable of cooperating with female or respectively male firm attachment means of the frame (1).

2. The foldable bicycle according to claim 1, wherein the distal end of the horizontal arms (19a, 19b) of the rear arm (15) bears the axis of the hub of the rear wheel (16).

3. The foldable bicycle according to claim 1, wherein the distal end of the rear oblique arms (20a, 20b) of the rear arm (15) bears the axis of the hub of the rear wheel (16).

4. The foldable bicycle according to claim 1, wherein the frame (1) consists in a triangular frame consisting of a so-called seat tube (2), of an oblique tube (3) and of a horizontal tube (4), the ends of the oblique tube (3) and of the horizontal tube (4) being firmly attached to the seat tube (2) and to the fork tube (5), respectively.

5. The foldable bicycle according to claim 1, wherein the horizontal arms (19a, 19b) of the rear arm (15) are mounted so as to pivot about the axis of the crankset casing (12), said crankset casing (12) bearing the axis of the driving pinion (13).

6. The foldable bicycle according to claim 5, wherein each horizontal arm (19a, 19b) of the rear arm (15) includes jointing means consisting of a semi-annular fixed jaw (22) to the free end of which is jointed a semi-annular mobile jaw (23) provided with means (24) for attaching said mobile jaw (23) to the fixed jaw (22).

7. The foldable bicycle according to claim 6, wherein each annular fixed jaw (22) includes a pin (26) onto which the horizontal arm (19a, 19b) of the rear arm (15) is capable of being fitted.

8. The foldable bicycle according to claim 6, wherein it includes two annular rolling bearings (32) respectively extending on either side of the frame (1) on the cylindrical crankset casing (12) which protrudes on either side of the frame (1), the fixed (22) and mobile (23) jaws of the jointing means being firmly attached by clamping to said annular rolling bearings (32).

9. The foldable bicycle according to claim 1, wherein the proximal end of the rear oblique arms (20a, 20b) is provided with an axis (33) extending perpendicularly to said rear oblique arms (20a, 20b), i.e. perpendicularly to the sagittal plane of the frame (1), forming a tie rod (33) capable of cooperating with notches (34) with a U-shaped section formed at the free end of at least two tabs (35) extending from the seat tube (2) towards the rear and comprising at its free ends a nut (36) and means (37) for clamping and pulling under tension said tie rod (33), respectively, in order to block the tie rod (33) in the notches (34).

10. The foldable bicycle according to claim 1, wherein the proximal end of the rear oblique arms (20a, 20b) is provided with a groove with a U-shaped section, the longitudinal axis of which extends perpendicularly to said rear oblique arms (20a, 20b), i.e. perpendicularly to the sagittal plane of the frame (1), and capable of receiving an axis firmly attached to the frame (1) and extending perpendicularly to the sagittal plane, said axis forming a tie rod which comprises at its free ends a nut and means for clamping an pulling under tension said tie rod, respectively, in order to block the tie rod in the groove.

11. The foldable bicycle according to claim 9, wherein the clamping and pulling means (37) consist of a handle (38) rotatably mounted around an axis (39) perpendicular to the longitudinal axis of the tie rod (33) and cooperating with the flanks of the tabs (35) or of the proximal end of the rear oblique arms (20a, 20b).

12. The foldable bicycle according to claim 1, wherein the rear arm (15) includes a damping means (67) positioned between the axis of the hub of the rear wheel (7) and the means for firmly attaching the rear oblique arms (20a, 20b) to the frame (1).

13. The foldable bicycle according to claim 1, wherein the rear oblique arms (20a, 20b) converge into a single tube segment (66) in proximity to their distal ends, said single tube segment (66) being provided with means for firmly attaching the rear oblique arms (20a, 20b) to the frame (1).

14. The foldable bicycle according to claim 1, folded and stored in a bag (51) defining an inner volume inscribed in a parallelepiped having a length and a height between 1.2 and 1.4 times the diameter of the wheels (7, 16) of said bicycle.

15. A jointing device of a so-called rear arm (15) bearing the hub of the rear wheel of a bicycle on a frame (1) bearing a crankset casing (12), including:
a semi-annular fixed jaw (22) firmly attached to said rear arm (15) and to the end of which is jointed a semi-annular mobile jaw (23) provided with means for attaching said mobile jaw (23) to the fixed jaw (22),
said fixed (22) and mobile (23) jaws being positioned on the crankset casing (12) so that the rear arm (15) is mounted so as to pivot about the axis of said crankset casing (12).

16. The jointing device according to claim 15, wherein each semi-cylindrical annular fixed jaw (22) includes a pin (26) onto which the rear arm (15) is capable of being fixed.

17. The jointing device according to claim 15, wherein it includes two annular rolling bearings (32) firmly attached to the cylindrical crankset casing (12) which protrudes on either side of the frame (1), said rolling bearings (32) respectively extending on either side of the frame (1) and the fixed (22) and mobile (23) jaws being firmly attached by clamping to said annular rolling bearings (32).

18. The foldable bicycle according to claim 1, folded and stored in a bag (151) defining an inner volume inscribed in a parallelepiped having a length and a height between 1.1 and 1.3 times the diameter of the wheels (107, 116) of said bicycle, and preferably between 1.18 and 1.2 times the diameter of the wheels (107,116).

19. The foldable bicycle according to claim 18, wherein the bag (151) has a length and a height between 1.1 and 1.3 times the diameter of the wheels (107, 116) of said bicycle, and preferably between 1.18 and 1.2 times the diameter of the wheels (107, 116).

20. The foldable bicycle according to claim 19, wherein the bag has a depth between 440 and 460 mm.

21. The foldable bicycle according to claim 19, wherein the bag (151) is obtained in a semi-rigid material.

22. The foldable bicycle according to claim 19, wherein the bag (151) consists of a base (152) and of at least one shell (158) capable of cooperating with said base (152) so that the shell (158) and the base (152) form a global parallelpipedal volume in the closed position.

23. The foldable bicycle according to claim 22, wherein the bag (151) consists of a base (152) and of two shells (158) respectively jointed along two opposite edges of the base (152), each shell (158) including closing means and complementary closing means so that said shells (158) form a globally parallelepipedal volume in the closed position.

24. The foldable bicycle according to claim 23, wherein the upper face of the base (152) having a rectangular shape includes two parallelepipedal recesses (159) extending parallel along the longitudinal edges of the base (152), on either side of the sagittal plane of symmetry of the base (152), said recesses (159) being capable of receiving the front (107) and rear (116) wheels when they are stored in the bag (151) on the one hand, and two other so-called side parallelepipedal recesses (160) globally extending in the sagittal plane of the base (152) on the other hand, respectively in proximity to the side edges of said base (152) and capable of respectively receiving the pinions of the crankset casing of the bicycle and the lower end of the fork of said bicycle.
